(19) United States
(12) Patent Application Publication
(10) Pub. No.: US 2026/0151799 A1
(43) Pub. Date: Jun. 4, 2026

(54) DEVICE FOR REMOVING FOREIGN SUBSTANCES

(71) Applicant: Hitachi High-Tech Corporation, Minato-ku, Tokyo (JP)

(72) Inventor: Tomonari MISAWA, Tokyo (JP)

(21) Appl. No.: 19/123,915

(22) PCT Filed: Sep. 7, 2023
(86) PCT No.: PCT/JP2023/032753

§ 371 Date: Apr. 24, 2025

(30) Foreign Application Priority Data
Nov. 24, 2022 (JP) 2022-187398

(51) Int. Cl. B07B 1/28; B07B 1/10

(52) U.S. Cl. CPC B07B 1/28; B07B 1/10

(57) ABSTRACT

An object of the invention is to provide a foreign substance removing device that is effective even for highly adhesive powder. Therefore, the foreign substance removing device of the invention includes: a substrate on which powder is to be placed; and a classification unit configured to classify powder to be collected and a foreign substance particle to be removed. The classification unit includes a classification mesh, a vibration unit that vibrates the substrate and/or the classification mesh, and a pressing unit that presses the classification mesh against the powder. In this way, by pressing the mesh against the powder and vibrating the powder, agglomerates of the powder can be de-agglomerated, a classification can be performed at the same time, and thus a foreign substance can be removed even for highly adhesive powder.

### TECHNICAL FIELD

The present invention relates to a foreign substance removing device that removes foreign substance particles mixed in powder.

### BACKGROUND ART

PTL 1 is known as a technique for removing foreign substance particles mixed in powder. PTL 1 discloses a foreign substance removing method in which vibration is applied to powder to form a thin layer to expose foreign substance particles on a surface, and a surface of a powder layer is imaged to detect foreign substances.

### CITATION LIST

### Patent Literature

PTL 1: JP 2004-333365A

### SUMMARY OF INVENTION

### Technical Problem

In the case of highly adhesive powder, agglomerates may be formed due to an adhesive force between particles. However, since it is not always possible to de-agglomerate the agglomerates only by applying vibration to the powder, in the technique described in PTL 1, when foreign substance particles are incorporated into the aggregates, the foreign substance particles are not exposed to the surface, and it may be difficult to detect the foreign substances.

The invention has been made in view of the above problems, and an object of the invention is to provide a foreign substance removing device that is effective even for highly adhesive powder.

### Solution to Problem

In order to solve the above problems, a foreign substance removing device of the invention includes: a substrate configured to allow powder to be placed thereon; and a classification unit configured to classify powder to be collected and a foreign substance particle to be removed. The classification unit includes a classification mesh, a vibration unit that vibrates the substrate and/or the classification mesh, and a pressing unit that presses the classification mesh against the powder.

### Advantageous Effects of Invention

According to the invention, by pressing the mesh against the powder and vibrating the powder, agglomerates of the powder can be de-agglomerated, a classification can be performed at the same time, and thus a foreign substance can be removed even for highly adhesive powder.

Problems, configurations, and effects other than those described above will become apparent in the following description of an embodiment of the invention.

### BRIEF DESCRIPTION OF DRAWINGS

FIG. 1 is a top view illustrating a schematic configuration of a foreign substance removing device according to Embodiment 1.

FIG. 2 is a cross-sectional view (a cross-sectional view along a line A-A in FIG. 1) illustrating a structure of a classification unit in Embodiment 1.

FIG. 3A is a cross-sectional view illustrating classification processing in Embodiment 1.

FIG. 3B is a cross-sectional view illustrating collection processing in Embodiment 1.

FIG. 4 is a cross-sectional view (a cross-sectional view taken along a line B-B in FIG. 1) illustrating a structure of an imaging unit in Embodiment 1.

FIG. 5 is a cross-sectional view illustrating a structure of a classification unit in Embodiment 2.

FIG. 6 is a cross-sectional view illustrating a structure of a classification unit in Embodiment 3.

FIG. 7 is a top view illustrating a schematic configuration of a foreign substance removing device according to Embodiment 4.

FIG. 8 is a cross-sectional view illustrating a structure of a primary classification unit 51 in Embodiment 4.

### DESCRIPTION OF EMBODIMENTS

Hereinafter, an embodiment according to the invention will be described with reference to the drawings. The embodiment is an example for describing the invention, and is omitted and simplified as appropriate for clarity of description. The invention can be implemented in various other aspects. Unless otherwise specified, each component may be single or plural.

In order to facilitate understanding of the invention, the position, size, shape, range, and the like of each component illustrated in the drawings may not represent an actual position, size, shape, range, or the like. Therefore, the invention is not necessarily limited to the position, size, shape, range, or the like disclosed in the drawings.

When there are a plurality of components having the same or similar functions, the plurality of components may be denoted by the same reference numerals assigned with different subscripts. When it is not necessary to distinguish the plurality of components, the description may be made by omitting the subscripts.

### Embodiment 1

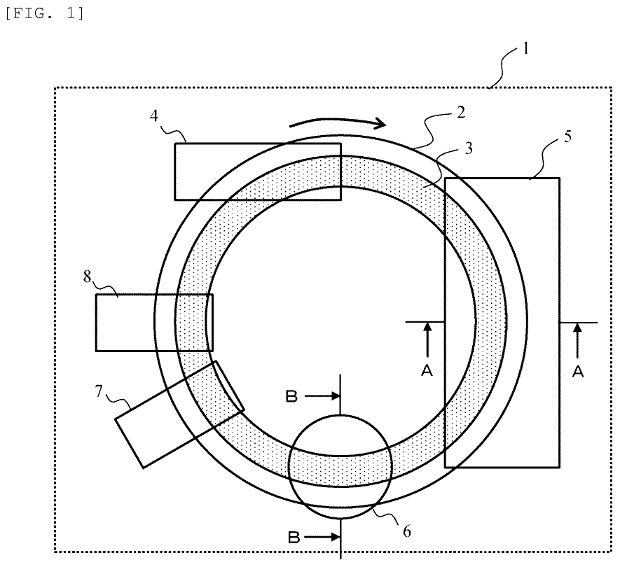

Embodiment 1 will be described with reference to FIGS. 1 to 4. FIG. 1 is a top view illustrating a schematic configuration of a foreign substance removing device according to Embodiment 1. As illustrated in FIG. 1, a foreign substance removing device 1 includes a turntable 2, a feeder 4, a classification unit 5, an imaging unit 6, a non-defective product collection unit 7, a defective product collection unit 8, and a control unit (not illustrated). The feeder 4, the classification unit 5, the imaging unit 6, the non-defective product collection unit 7, and the defective product collection unit 8 are positioned at different positions from upstream to downstream of the turntable 2 in a rotation direction.

A groove portion 3 is formed in a part of an upper surface of the turntable 2, and powder is supplied to the groove portion 3 by the feeder 4. A material for the turntable 2 is desirably stainless steel or aluminum in order to obtain sufficient strength and rigidity, but when it is desired to prevent a foreign metal substance from being mixed into the powder, it is desirable to form a non-metal layer such as a resin coating such as a fluororesin coating or a DLC coating on a surface of the groove portion 3 or an entire surface of the turntable 2. A depth of the groove portion 3 is set to be equal to or less than a lower limit value of a size of a foreign substance particle to be removed.

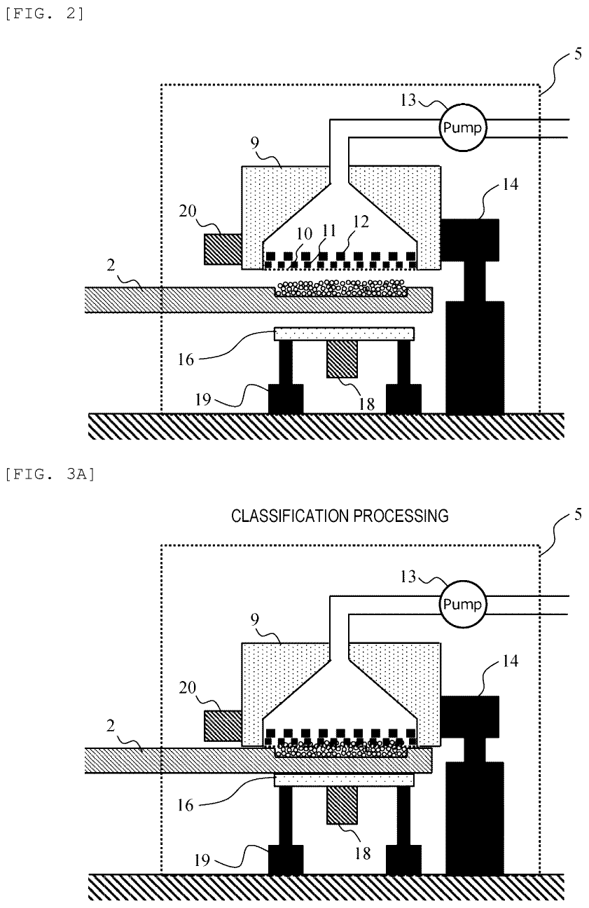

The classification unit 5 classifies powder to be collected and foreign substance particles to be removed, and specifically, exposes the foreign substance particles to a surface from a powder layer supplied to the groove portion 3. FIG. 2 is a cross-sectional view (a cross-sectional view taken along a line A-A in FIG. 1) illustrating a structure of the classification unit in Embodiment 1. The classification unit 5 includes a mesh housing 9, a classification mesh 10, a space forming portion (a space forming mesh 11), a pressing unit (a mesh pressing plate 12), an aspiration mechanism (a pump 13), a first vibration unit (a base 16 and a vibrator 18), a second vibration unit (a vibrator 20), a first lifting mechanism 14, and a second lifting mechanism 19.

The classification mesh 10, the space forming mesh 11, and the mesh pressing plate 12 are attached to the mesh housing 9 in order from a powder side (a lower side). Each of openings of the classification mesh 10 is equal to or smaller than a lower limit value of the size of the foreign substance particle to be removed and larger than a median particle diameter of the powder. Here, even in a case where each of the openings of the classification mesh 10 is larger than the size of the foreign substance particle, when each of the openings of the classification mesh 10 is slightly larger, the foreign substance particle can be substantially removed and throughput is improved, but when each of the openings of the classification mesh 10 is equal to or smaller than the size of the foreign substance particle, the foreign substance particle can be reliably removed and reliability is improved. The space forming mesh 11 is installed between the classification mesh 10 and the mesh pressing plate 12, is a thick mesh made of a large diameter wire, and has a plurality of spaces for accommodating the powder passing through the classification mesh 10. A cross-sectional area of each of the spaces of the space forming mesh 11 in a horizontal direction is larger than a cross-sectional area of each of the openings of the classification mesh 10. That is, each of openings of the space forming mesh 11 is larger than each of the openings of the classification mesh 10. A plurality of space forming meshes 11 may be installed in an overlapping manner according to a volume of the powder passing through the classification mesh 10. The mesh pressing plate 12 is used to flatten a shape of the mesh when the classification mesh 10 is pressed against the powder via the space forming mesh 11, and is a highly rigid plate having a plurality of openings penetrating vertically therethrough for aspirating the powder.

When it is desired to prevent a foreign metal substance from being mixed into the powder, it is desirable to use a resin mesh such as nylon as a material for the classification mesh 10 and the space forming mesh 11. It is also desirable to form the mesh pressing plate 12 and the mesh housing 9 by a resin, but when sufficient rigidity cannot be obtained, the mesh pressing plate 12 and the mesh housing 9 may be formed by a metal such as stainless steel or aluminum. In this case, it is desirable to form a non-metal layer such as a resin coating of a fluororesin coating or the like or a DLC coating on a position that comes into contact with the powder.

The mesh housing 9 is attached to the first lifting mechanism 14, and can move the classification mesh 10 closer to or away from the powder. When the classification mesh 10 is pressed against the powder, the control unit controls the first lifting mechanism 14 to adjust a height of the mesh housing 9 to follow a decrease in layer thickness of the powder layer as the powder passes through the classification mesh 10. The mesh housing 9 may be made to follow the decrease in layer thickness of the powder layer generated during the classification by an elastic member such as a spring. The mesh housing 9 is connected to the pump 13 that aspirates the powder through the openings of the mesh pressing plate 12.

On a lower side of the turntable 2, in addition to the second lifting mechanism 19, the base 16 and the vibrator 18 are installed as the first vibration unit for vibrating the turntable 2. The base 16 is formed of a metal such as aluminum or stainless steel, and vibration can be applied by the vibrator 18 fixed to a lower side of the base 16. The base 16 is attached to the second lifting mechanism 19, and can be moved closer to or away from a lower surface of the turntable 2. When it is desired to prevent a foreign metal substance from being mixed into the powder, it is desirable to attach a resin sheet such as a fluororesin sheet to an upper surface of the base 16 to prevent generation of metal particles due to friction with the turntable 2.

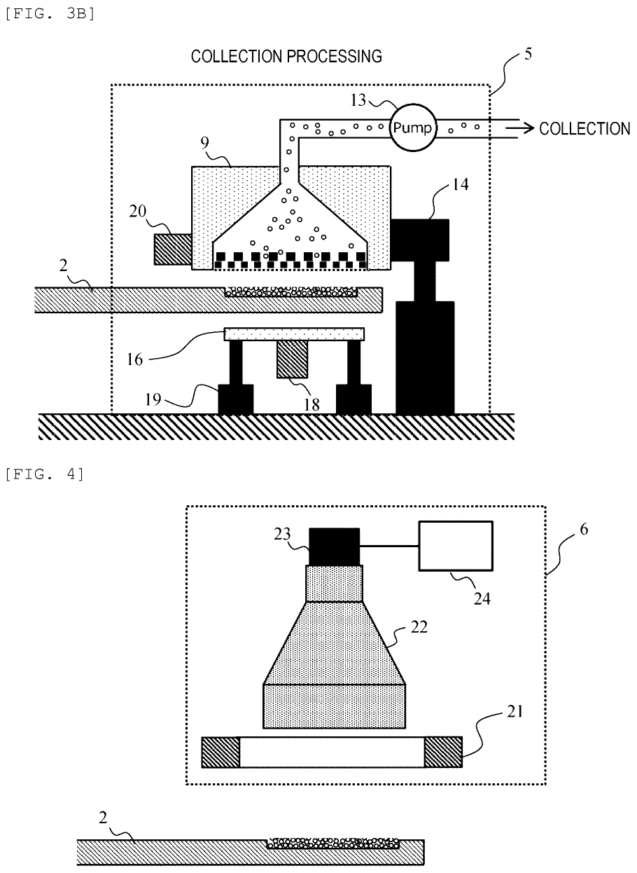

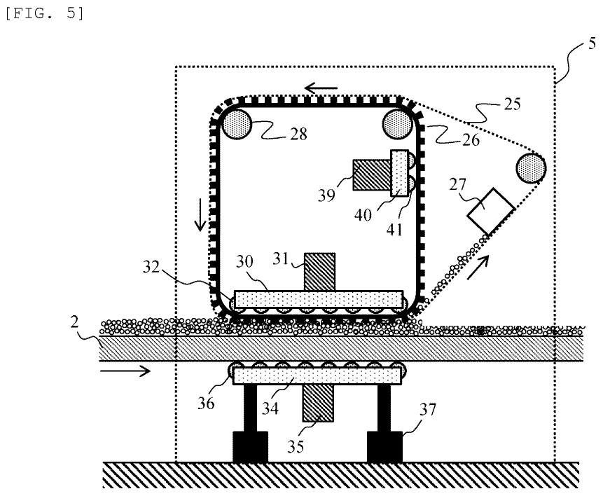

An operation of the classification unit 5 will be described with reference to FIGS. 3A and 3B. FIG. 3A is a cross-sectional view illustrating classification processing in Embodiment 1, and FIG. 3B is a cross-sectional view illustrating collection processing in Embodiment 1. In the present embodiment, a series of processing is repeated in which the turntable 2 rotates by a predetermined angle and then stops, the classification processing illustrated in FIG. 3A and the collection processing illustrated in FIG. 3B are executed, and then the turntable 2 rotates again.

First, the classification processing will be described. With the turntable 2 stopped, the control unit controls the first lifting mechanism 14 to press the mesh pressing plate 12 and the classification mesh 10 together with the mesh housing 9 against the turntable 2 and the powder. At this time, the control unit controls the second lifting mechanism 19 to press the base 16 against the turntable 2. Further, the control unit controls the vibrator 18 to vibrate the turntable 2 via the base 16 while a lower surface of the classification mesh 10 is in close proximity to and at approximately the same height as an upper surface of the turntable 2 (other than the groove portion 3). Accordingly, the powder is fluidized, and particles smaller than the opening of the classification mesh 10 pass through the classification mesh 10.

By applying vibration while pressing against the powder, aggregation can be de-agglomerated and fluidized even in the case of highly adhesive powder. At this time, when the control unit vibrates the classification mesh 10 together with the mesh housing 9 using the vibrator 20 serving as the second vibration unit, the fluidization is further promoted, a flow velocity at which the powder passes through the classification mesh 10 is further increased, and the throughput can be improved.

Next, the collection processing will be described. With the turntable 2 stopped, the control unit controls the first lifting mechanism 14 to move the mesh pressing plate 12 and the classification mesh 10 together with the mesh housing 9 away from the turntable 2 and the powder. At this time, the control unit controls the second lifting mechanism 19 to move the base 16 away from the turntable 2. Further, with the classification mesh 10 away from the powder, the control unit drives the pump 13 to aspirate the powder passing through the classification mesh 10. The aspirated powder does not contain foreign substance particles, and is therefore collected as a non-defective product in the non-defective product collection unit 7. When the pump 13 aspirates the powder, the mesh housing 9 may be vibrated by the vibrator 20 to facilitate the aspiration of the powder clogged in the mesh. Here, as described above, since the depth of the groove portion 3 is set to be equal to or smaller than the size of the foreign substance particle to be removed, a distance from a powder placement surface of the turntable 2 (a bottom surface of the groove portion 3) to a lower surface of the classification mesh 10 during the classification processing is also equal to or less than the size of the foreign substance particle.

Therefore, after the classification processing, a layer thickness of the powder remaining on the turntable 2 is substantially the same as the depth of the groove portion 3, and at least a part of the foreign substance particles to be removed is exposed on the surface of the powder layer.

A residue remaining on the turntable 2 after the classification processing and the collection processing are completed is sent to the imaging unit 6 by the rotation of the turntable 2. Thereafter, it is determined, based on the image taken by the imaging unit 6, whether foreign substance particles are contained in the residue. When the powder layer contains foreign substance particles, the foreign substance particles can be captured by the image since the foreign substance particles are exposed on the surface of the powder layer as described above.

FIG. 4 is a cross-sectional view (a cross-sectional view taken along a line B-B in FIG. 1) illustrating a structure of the imaging unit in Embodiment 1.

As illustrated in FIG. 4, the imaging unit 6 includes an illuminator 21, a lens 22, a CCD 23, and an image processing unit 24. The illuminator 21 irradiates the powder with light from the imaging unit 6 side, and for example, a ring illuminator is used. The lens 22 is attached to the CCD 23, and an image of the powder surface is acquired by the CCD 23 at an appropriate magnification. The acquired image is analyzed by the image processing unit 24 to determine the presence or absence of foreign substance particles. As a method for determining the foreign substance particle, for example, there is a method using a difference in particle shape, a difference in light intensity or chromaticity of reflected light or scattered light, or the like. The determination of the foreign substance particles may be performed by the control unit instead of the image processing unit 24.

The powder, for which the presence or absence of foreign substance particles is determined in the imaging unit 6, is sent by the turntable 2 to the non-defective product collection unit 7 or the defective product collection unit 8. The pump 13 is connected to the non-defective product collection unit 7 and the defective product collection unit 8, and the powder aspirated by the pump 13 is collected. The powder determined as the foreign substance particle “absent” is collected by the non-defective product collection unit 7, and the powder determined as the foreign substance particle “present” is collected by the defective product collection unit 8.

As described above, according to the present embodiment, by pressing the mesh against the powder and vibrating the powder, agglomerates of the powder can be de-agglomerated, the classification can be performed at the same time, and thus the foreign substance particles can be exposed on the surface even for highly adhesive powder, and as a result, the foreign substance particles contained in the powder can be determined and removed.

In the present embodiment, the powder is placed on the turntable 2, and the turntable 2 rotates to move the position of the powder, but instead of the turntable 2, another substrate such as a conveyor may move linearly to move the position of the powder. In the present embodiment, the aggregation of the powder is de-agglomerated mainly by the vibration applied to the powder by the first vibration unit via the turntable 2, but the aggregation of the powder may be de-agglomerated only by the vibration applied to the powder by the second vibration unit. Further, in the present embodiment, the collection processing is performed after the classification processing, which enables highly reliable classification and collection, but when there is a gap between the mesh housing 9 and the turntable 2 during the classification processing and the aspiration is enabled, the classification processing and the collection processing may be performed simultaneously to improve the throughput.

### Embodiment 2

Embodiment 2 will be described with reference to FIG. 5. FIG. 5 is a cross-sectional view illustrating a structure of a classification unit in Embodiment 2. In Embodiment 2, while powder is conveyed in a horizontal direction, a classification mesh 25 also moves along a conveyance direction of the powder, thereby performing a classification continuously without stopping rotation of the turntable 2 and improving throughput. An overall configuration of a foreign substance removing device according to Embodiment 2 is the same as that in Embodiment 1 illustrated in FIG. 1, but the configuration of the classification unit 5 in Embodiment 2 is different from that in Embodiment 1. Hereinafter, the configuration of the classification unit 5 in Embodiment 2 will be specifically described.

As illustrated in FIG. 5, the classification unit 5 in Embodiment 2 includes the classification mesh 25, a space forming portion (a space forming sheet 26), a pressing unit (a base 30 and a roller 32), a collection unit 27, a turning roller 28, a first vibration unit (a base 34, a vibrator 35, and a roller 36), a second vibration unit (a vibrator 31), a third vibration unit (a base 40, a vibrator 39, and a roller 41), and a support 37.

The classification mesh 25 and the space forming sheet 26 are moved by the turning roller 28 in synchronization with conveyance of the turntable 2. Here, since the powder rotates together with the turntable 2, a speed of the powder on an outer diameter side is higher than a speed of the powder on an inner diameter side. On the other hand, the classification mesh 25 is cyclically moved at a constant speed in a tangential direction of the turntable 2. When a moving speed of the classification mesh 25 is the same as the speed of the powder on the inner diameter side, the speed of the classification mesh 25 is too slow, and the powder is likely to accumulate upstream. On the other hand, when the moving speed of the classification mesh 25 is the same as the speed of the powder on the outer diameter side, the speed of the classification mesh 25 is too high, and a surface of a powder layer may be disturbed or the powder may be sputtered. Therefore, in the present embodiment, the moving speed of the classification mesh 25 is set to a speed that is higher than the speed of the powder on the inner diameter side and lower than the speed of the powder on the outer circumferential side, and desirably is set to a speed intermediate between a speed of the powder on the innermost diameter side and a speed of the powder on the outermost diameter side. Accordingly, a speed difference between the classification mesh 25 and the powder can be prevented, and reliability of the device can be improved. Further, when a diameter of the turntable 2 is sufficiently larger than a width of the powder layer, the speed difference between the classification mesh 25 and the powder can be further prevented, and the reliability can be further improved.

Each of openings of the classification mesh 25 is equal to or smaller than a lower limit value of the size of the foreign substance particle to be removed and larger than a median particle diameter of the powder. The space forming sheet 26 is formed by fixing a thick mesh made of a large diameter wire to a sheet without holes, and is placed inside the classification mesh 25 (on a side opposite the turntable). Each of openings of the space forming sheet 26 is larger than each of the openings of the classification mesh 25, and the space forming sheet 26 has a plurality of spaces for accommodating the powder passing through the classification mesh 25 of the classification mesh 25. Since a sheet having no hole is used as the space forming sheet 26, the powder can be prevented from being mixed into a structure inside the space forming sheet 26, that is, the pressing unit, the turning roller 28, the second vibration unit, and the third vibration unit. Depending on a volume of the powder passing through the classification mesh 25, a plurality of meshes of the space forming sheet 26 may be installed in an overlapping manner. When it is desired to prevent a foreign metal substance from being mixed into the powder, it is desirable to use a resin mesh such as nylon or fluororesin as a material for the classification mesh 25 and the space forming sheet 26.

The pressing unit presses the classification mesh 25 and the space forming sheet 26 against the powder on the turntable 2 and applies vibration to the powder on the turntable 2, and includes the base 30 and the roller 32. The base 30 is supported using an elastic member such as a spring so as to apply a constant pressing force to the classification mesh 25 and the space forming sheet 26. The roller 32 is fixed to the base 30 and freely rotates following the movement of the space forming sheet 26. The vibrator 31 serving as the second vibration unit is also fixed to the base 30, and vibration is transmitted from the vibrator 31 to the roller 32.

The first vibration unit vibrates the turntable 2, and includes the base 34, the vibrator 35, and the roller 36. The base 34 is made of metal or the like, and can be vibrated by the vibrator 35 fixed to a lower side thereof. The roller 36 is fixed to an upper side of the base 34, receives vibration from the vibrator 35, and freely rotates following the movement of the turntable 2. In addition to the first vibration unit, the support 37 is provided below the turntable 2. The support 37 can be implemented using an elastic member such as a spring so as to apply a constant pressing force to the turntable 2.

The third vibration unit is used to peel off the powder adhering to the space forming sheet 26 through the classification mesh 25, and includes the base 40, the vibrator 39, and the roller 41. The vibrator 39 and the roller 41 are fixed to the base 40, and vibration is transmitted from the vibrator 39 to the roller 41. The roller 41 freely rotates following the movement of the space forming sheet 26.

The collection unit 27 collects the powder passing through the classification mesh 25. The collected powder does not contain foreign substance particles to be removed, and is therefore used as a non-defective product. When the collection unit 27 collects the powder, for example, aspiration is performed by a pump (not illustrated).

According to the present embodiment, since the surface of the powder layer can be classified continuously while the turntable 2 is rotating, the throughput is further improved. Since the vibration is applied to the rotating turntable 2 via the roller 36 and the pressing force is applied to the classification mesh 25 and the space forming sheet 26 via the roller 32 during the movement, wear or the like on a contact surface can be prevented.

Depending on a layout around an installation position of the foreign substance removing device, a configuration in which another substrate such as a conveyor moves linearly may be adopted instead of the turntable 2. In this case, a speed difference between the classification mesh 25 and the powder can be eliminated, which leads to improvement in reliability. Further, in the present embodiment, although the configuration in which the classification mesh 25 is circulated in a loop has been described as an example, the classification mesh 25 may be implemented in a roll-to-roll manner, and rolls may be replaced periodically.

### Embodiment 3

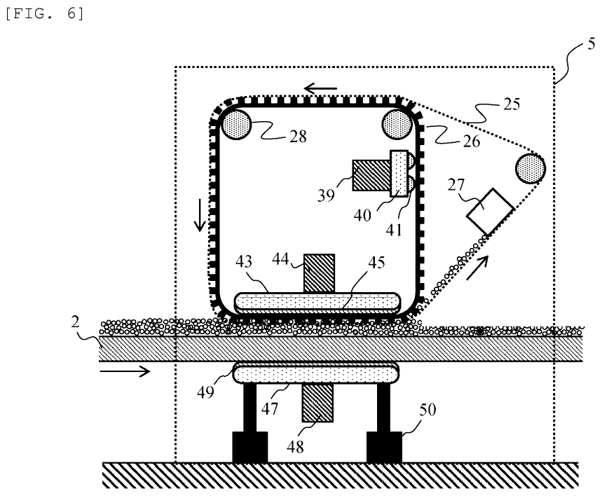

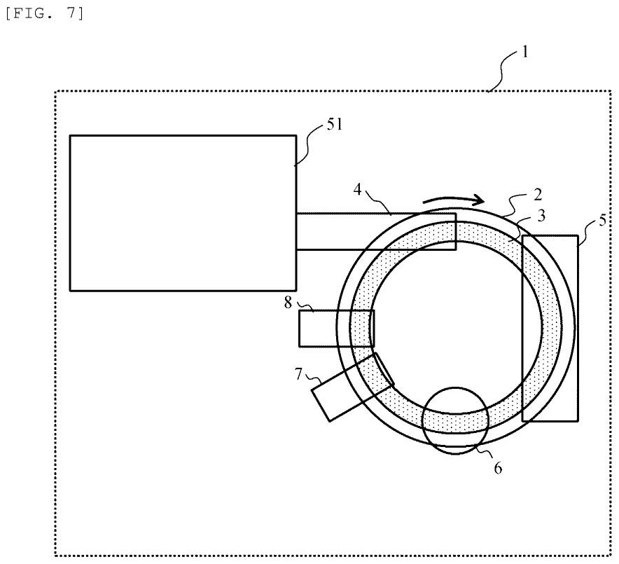

Embodiment 3 will be described with reference to FIG. 6. FIG. 6 is a cross-sectional view illustrating a structure of a classification unit in Embodiment 3. In Embodiment 2, since vibration generated by a vibrator is transmitted to a roller via a base and the vibration is applied from the roller to the turntable 2 and the classification mesh 25, attenuation of vibration energy is unavoidable. Therefore, in Embodiment 3, the attenuation of vibration energy can be prevented by sliding the turntable 2 or the like with a low friction layer formed on a base surface without using a roller. An overall configuration of the foreign substance removing device according to Embodiment 3 is the same as that in Embodiments 1 and 2, but a configuration of the classification unit 5 in Embodiment 3 is different from that in each embodiment. Hereinafter, the configuration of the classification unit 5 in Embodiment 3 will be specifically described.

As illustrated in FIG. 6, a classification unit in Embodiment 3 includes the classification mesh 25, a space forming portion (the space forming sheet 26), a pressing unit (a base 43), the collection unit 27, the turning roller 28, a first vibration unit (a base 47 and a vibrator 48), a second vibration unit (a vibrator 44), a third vibration unit (the base 40, the vibrator 39, and the roller 41), and a support 50. Configurations of the classification mesh 25, the space forming portion, the collection unit 27, the turning roller 28, the second vibration unit, and the third vibration unit are the same as those in Embodiment 2.

The pressing unit in Embodiment 3 presses the classification mesh 25 and the space forming sheet 26 against the powder on the turntable 2 and applies vibration to the powder on the turntable 2 as in Embodiment 2, and includes the base 43, but does not include a roller unlike Embodiment 2. A low friction layer 45 is formed on a lower surface of the base 43 in Embodiment 3, that is, a surface in contact with the space forming sheet 26. The base 43 is slid on the space forming sheet 26 with low friction, and is formed by, for example, attaching a resin sheet such as a fluororesin or high-density polyethylene to the base 43, applying a coating such as a fluororesin or DLC to the base 43, or providing unevenness on the surface of the base 43 by plating, sandblasting, or the like.

The first vibration unit in Embodiment 3 vibrates the turntable 2 as in Embodiment 2, and includes the base 47 and the vibrator 48, but does not include a roller unlike Embodiment 2. A low friction layer 49 is formed on an upper surface of the base 47 in Embodiment 3, that is, a surface in contact with the turntable 2. The low friction layer 49 slides on the turntable 2 with low friction, and is formed by, for example, attaching a resin sheet such as a fluororesin or high-density polyethylene to the base 47, applying a coating such as a fluororesin or DLC to the base 47, or providing unevenness to the surface of the base 47 by plating, sandblasting, or the like.

According to the present embodiment, the vibration can be applied to the powder while preventing the attenuation of the vibration energy. The turntable 2 and the space forming sheet 26 can be pressed against an entire surface of the base, and the throughput of the classification can be further improved. In the present embodiment, the low friction layer 49 is formed on the upper surface of the base 47 of the first vibration unit, but a low friction layer may be formed on the lower surface of the turntable 2. In the present embodiment, the roller 41 is used in the third vibration unit, but instead of the roller 41, a low friction layer or the like may be formed on the base 40.

### Embodiment 4

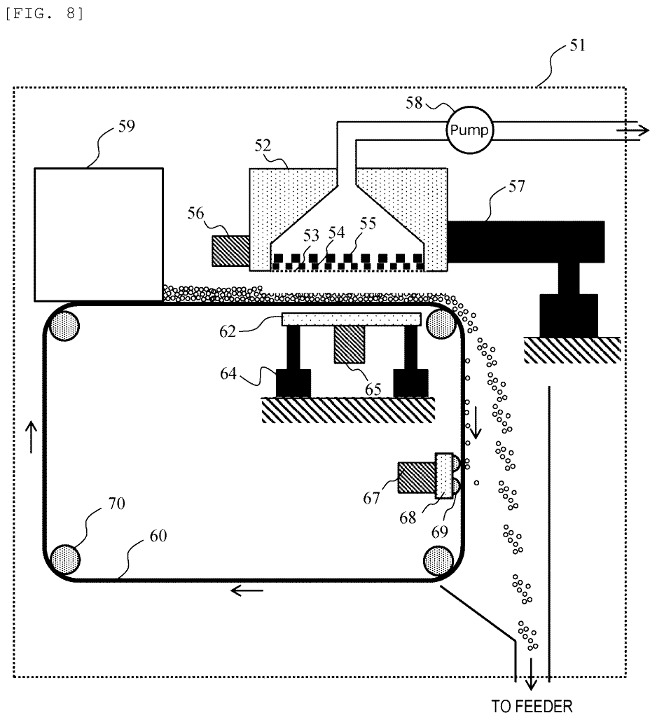

Embodiment 4 will be described with reference to FIGS. 7 and 8. In Embodiments 1 to 3, all of powder to be inspected is supplied to the turntable 2, and classification and imaging of a powder surface are performed, but for example, when foreign substance particles to be detected become small, it is necessary to narrow a field of view and increase an imaging resolution, and thus imaging throughput may not satisfy a required amount. Therefore, in the present embodiment, by performing a primary classification before supplying powder to the turntable 2, an amount of powder required for imaging is reduced, and inspection throughput is improved.

FIG. 7 is a top view illustrating a schematic configuration of a foreign substance removing device according to Embodiment 4. As illustrated in FIG. 7, the foreign substance removing device 1 includes the turntable 2, the feeder 4, the classification unit 5, the imaging unit 6, the non-defective product collection unit 7, the defective product collection unit 8, a control unit (not illustrated), and a primary classification unit 51. The classification unit 5 is positioned upstream of the imaging unit 6, the feeder 4 is positioned upstream of the classification unit 5, and the primary classification unit 51 serving as another classification unit is positioned upstream of the feeder 4. The configuration other than the primary classification unit 51 is the same as that in Embodiment 1. The primary classification unit 51 separates the powder into powder containing no foreign substances and powder containing foreign substances before supplying the powder to the turntable 2 via the feeder 4. The powder containing no foreign substances is collected as a non-defective product, and the powder containing foreign substances is supplied to the feeder 4.

FIG. 8 is a cross-sectional view illustrating a structure of the primary classification unit 51 in Embodiment 4. The primary classification unit 51 includes a feeder 59, a mesh housing 52, a classification mesh 53, a space forming portion (a space forming mesh 54), a pressing unit (a mesh pressing plate 55), an aspiration mechanism (a pump 58), a powder conveyance sheet 60, a turning roller 70, a first vibration unit (a base 62 and a vibrator 65), a second vibration unit (a vibrator 56), a third vibration unit (a base 68, a vibrator 67, and a roller 69), a first lifting mechanism 57, and a second lifting mechanism 64.

The feeder 59 quantitatively supplies powder on the powder conveyance sheet 60. The powder conveyance sheet 60 is formed in a loop shape and conveys the powder while being cyclically moved by the turning roller 70. When it is desired to prevent a foreign metal substance from being mixed into the powder, it is desirable to use a resin material such as a fluororesin as a material for the powder conveyance sheet 60.

The classification mesh 53, the space forming mesh 54, and the mesh pressing plate 55 are attached to the mesh housing 52 in order from a powder side (a lower side). In the classification mesh 53, configurations of the space forming mesh 54 and the mesh pressing plate 55 are the same as the configurations of the classification mesh 10, the space forming mesh 11, and the mesh pressing plate 12 in Embodiment 1.

Basic configurations of the pump 58, the first vibration unit, the second vibration unit, the first lifting mechanism 57, and the second lifting mechanism 64 are the same as those of the pump 13, the first vibration unit, the second vibration unit, the first lifting mechanism 14, and the second lifting mechanism 19 in Embodiment 1. The third vibration unit is used to peel off the powder adhering to the powder conveyance sheet 60, and a configuration thereof is basically the same as that of the third vibration unit in Embodiment 2.

In the present embodiment, a series of processing is repeated in which the powder conveyance sheet 60 moves a predetermined distance and then stops, the classification processing and the collection processing are performed, and then the powder conveyance sheet 60 moves again. Specific operations of the classification processing and the collection processing are basically the same as the operations described in Embodiment 1 with reference to FIGS. 3A and 3B. However, in the present embodiment, powder remaining on the powder conveyance sheet 60 after the collection processing is discharged from the primary classification unit 51 and supplied to the feeder 4.

According to the present embodiment, throughput of the entire device can be improved by performing the primary classification in advance before supplying the powder to the turntable 2.

The above embodiments have been described in detail to facilitate understanding of the invention, and the invention is not limited to those including all the configurations described above. A part of a configuration in one embodiment can be replaced with a configuration in another embodiment, and a configuration in one embodiment can also be added to a configuration in another embodiment. For example, in Embodiment 4, the classification unit 5 same as that in Embodiment 1 is used, and the classification unit 5 same as that in Embodiment 2 or Embodiment 3 may be used. Further, a part of a configuration in each embodiment may also be added to, deleted from, or replaced with another configuration.

### REFERENCE SIGNS LIST

1 foreign substance removing device
2 turntable
3 groove portion
4, 59 feeder
5 classification unit
6 imaging unit
7 non-defective product collection unit
8 defective product collection unit
9, 52 mesh housing
10, 25, 53 classification mesh
11, 54 space forming mesh
12, 55 mesh pressing plate
13, 58 pump
14, 57 first lifting mechanism
16, 30, 34, 40, 43, 47, 62, 68 base
18, 20, 31, 35, 39, 44, 48, 56, 65, 67 vibrator
19, 64 second lifting mechanism
21 illuminator
22 lens
23 CCD
24 image processing unit
26 space forming sheet
27 collection unit
28, 70 turning roller
32, 36, 41, 69 roller
37, 50 support
45, 49 low friction layer
51 primary classification unit
60 powder conveyance sheet

1. A foreign substance removing device comprising:
a substrate configured to allow powder to be placed thereon; and
a classification unit configured to classify powder to be collected and a foreign substance particle to be removed, wherein
the classification unit includes
a classification mesh,
a vibration unit that vibrates the substrate and/or the classification mesh, and
a pressing unit that presses the classification mesh against the powder.

2. The foreign substance removing device according to claim 1, wherein
each of openings of the classification mesh is equal to or smaller than a size of the foreign substance particle.

3. The foreign substance removing device according to claim 1, comprising:
a space forming portion with a plurality of spaces between the classification mesh and the pressing unit, wherein
a cross-sectional area of each of the spaces of the space forming portion in a horizontal direction is larger than a cross-sectional area of each of the openings of the classification mesh.

4. The foreign substance removing device according to claim 1, comprising:
an imaging unit configured to take an image of a residue on the substrate after the classification, wherein
whether the foreign substance particle is contained in the residue is determined based on an image taken by the imaging unit.

5. The foreign substance removing device according to claim 4, wherein
a distance from a powder placement surface of the substrate to the classification mesh during the classification is equal to or smaller than a size of the foreign substance particle.

6. The foreign substance removing device according to claim 1, wherein
the pressing unit has a plurality of openings penetrating the pressing unit vertically,
the foreign substance removing device comprises an aspiration mechanism configured to aspirate the powder through the openings, and
with the classification mesh in close proximity to the powder, vibration is applied to the powder by the vibration unit, and then, with the classification mesh separated from the powder, the powder is aspirated by the aspiration mechanism.

7. The foreign substance removing device according to claim 1, wherein
the substrate conveys the powder in a horizontal direction,
the classification mesh moves along a conveyance direction of the powder, and
the conveyance of the substrate and the movement of the classification mesh are synchronized.

8. The foreign substance removing device according to claim 7, wherein
the substrate is a turntable that rotates the powder,
the classification mesh is cyclically moved in a tangential direction of the substrate, and
a moving speed of the classification mesh is higher than a speed of the powder on an inner diameter side of the substrate and lower than a speed of the powder on an outer circumferential side of the substrate.

9. The foreign substance removing device according to claim 7, wherein
the pressing unit includes a roller or a low friction layer, and
the pressing unit presses the classification mesh via the roller or the low friction layer.

10. The foreign substance removing device according to claim 7, wherein
the vibration unit includes a roller or a low friction layer, and
the vibration unit vibrates the substrate and/or the classification mesh.

11. The foreign substance removing device according to claim 4, wherein
the substrate conveys the powder in a horizontal direction,
the classification unit is positioned upstream of the imaging unit, and
another classification unit is positioned upstream of the classification unit.
